(19) United States
(12) Patent Application Publication
(10) Pub. No.: US 2002/0059241 A1
(43) Pub. Date: May 16, 2002

(54) INTERNET SITE LINK METHOD AND APPARATUS

(76) Inventor: JOHN M. VAN RYZIN, MADISON, NJ (US)

Correspondence Address: FROMMER LAWRENCE & HAUG, 745 FIFTH AVENUE- 10TH FL., NEW YORK, NY, 10151, US

(21) Appl. No.: 09/106,988

(22) Filed: Jun. 29, 1998

(51) Int. Cl. G06F 7/00

(52) U.S. Cl. 707/10

(57) ABSTRACT

An automatic internet site link links a computer to an internet page at an internet page address by inputting a code, accessing a server database and determining from the server database the internet page address corresponding to the code input into the computer. A program for controlling the computer to automatically link to the internet page located at the internet page address in response to the code input to the computer accesses a server database, determines from the server database the internet page address corresponding to the code and links to the internet page located at the internet page address. A program for controlling the server database computer receives, via a modem connection, the code input to the remote computer, determines, from the server database resident to the server database computer, the internet page address corresponding to the code and returns the internet page address to the remote computer.

### BACKGROUND OF THE INVENTION

The present invention relates to an internet site link and, more particularly, to a device that automatically links a computer to an internet site, via a web browser, by scanning and interpreting a printed bar code UPC label.

Current web browsers are not user-friendly. In order to access a web-page, the user must execute the web browser, link to a search engine, search for the desired internet site home page and then link to that home page. This process is quite tedious for users, particularly those users who are not comfortable with the internet.

In addition to the normal amount of processor time needed to execute the web browser, linking to the search engine or web page is very time consuming because the web browser must access a remote internet server. This problem is compounded when the link to the search engine or web page is routed through a plurality of internet servers.

It is particularly problematic when the user desires to research on-line sales information, product updates or manuals because searching for such information is like searching for the proverbial needle in the hay stack of the information highway. To complicate matters, search engines, while they have advanced in searching capability in recent years, are still far from perfect and rarely yield the precise HTML (hypertext markup language) link desired by the user.

As a result, users often spend enormous amounts of time “surfing” the internet; linking from one page to the next. Considering that the user typically expends a great deal of time linking and searching web pages for a particular sales information, product update or user manual, it is understandable that most users end their search frustrated.

Heretofore, there has been no practical way to quickly link to a desired web page, particularly a products information page to research a particular sales information, product update or user manual.

### OBJECTS AND SUMMARY OF THE INVENTION

It is an object of the present invention to provide linking to a web page quickly and easily.

It is a further object of the present invention to provide linking to a particular web page to research products information.

It is yet another object of the present invention to provide linking to a particular products information web page to research sales information, product updates or user manuals.

In accordance with the foregoing objectives there is further provided an automatic internet site link apparatus for linking a computer to an internet page at an internet page address, comprising an input for inputting a code, a modem for accessing a server database and a processor for determining from the server database the internet page address corresponding to the code input into the computer.

In accordance with the foregoing objectives, there is also provided a method for controlling a computer to automatically link to an internet page located at an internet page address in response to a code input to the computer. A server database is accessed and the internet page address corresponding to the code is determined from the server database; whereupon the internet page located at the internet page address is linked.

As a feature of this invention, a server database computer is controlled by receiving, via a modem connection, a code input to a remote computer; determining, from a server database resident to the server database computer, an internet page address corresponding to the code; and returning the internet page address corresponding to the code.

### BRIEF DESCRIPTION OF THE DRAWINGS

A more complete appreciation of the present invention and many of its attendant advantages will be readily obtained by reference to the following detailed description considered in connection with the accompanying drawings, in which:

FIG. 1 illustrates the automatic linking device of the present invention;

FIG. 2 is a flow diagram of the program for controlling the client computer of the present invention; and

FIG. 3 is a flow diagram of the program for controlling the server database of the present invention.

### DETAILED DESCRIPTION OF THE PREFERRED EMBODIMENTS

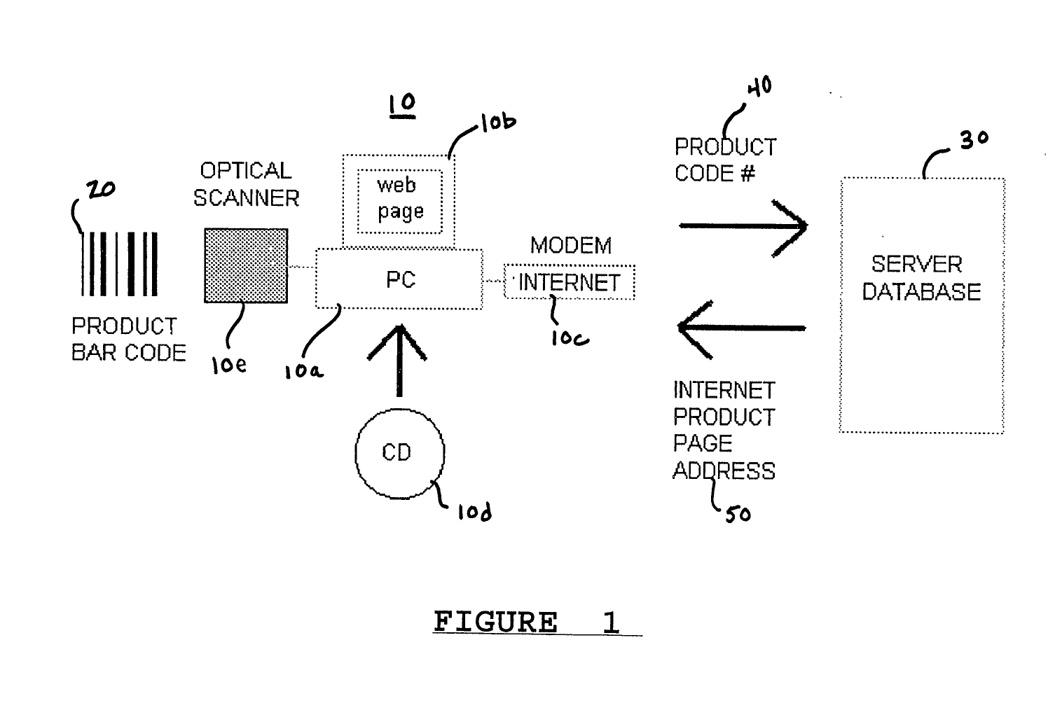

FIG. 1 illustrates the automatic linking device of the present invention which is described, as an example, in the environment of product updates; A computer 10 comprises a personal computer 10a coupled to a display monitor 10b for displaying a web page, a modem 10c for connecting to the internet, a CD drive 10d for recording/reproducing data and an optical scanner 10e for scanning a product bar code 20. The computer 10, via modem 10c, transmits product code numbers 40 to server database 30 and receives internet product page addresses 50 therefrom.

In operation, the client (or user) invokes “client” software, resident to computer 10, prompts the user to pass (or scan) optical scanner 10e over the product UPC bar code label 20. Optical scanner 10e, which is coupled to computer 10 via an input port, optically scans the UPC bar code, which is then converted by the client software into a corresponding product code number 40. Of course, any equivalent scanner or code may be employed in the present invention.

Client software accesses server database 30 via the internet connection established by modem 10c. The client software, in communication with the server software via the internet, requests from the server software an internet address corresponding to the product code number 40. Upon receiving the internet product page address 50, the client software invokes internet browsing software resident to computer 10 to link to the internet product page address which is returned by the server software.

The bar code is preferably a UPC bar code, but may be any equivalent code. In addition, the code may be any bar code found on any product which, as will be appreciated, is advantageous because the user can research the product without knowing the manufacturer simply by utilizing the present invention. For example, the user simply scans the bar code on a computer program box, article of clothing or audio/video equipment and the present invention automatically links/accesses the product web page or bulletin board system (BBS).

Preferably, the server software is a database program which accesses a resident database of a list of UPC bar codes and the related manufacturer's internet site page address.

As one example, the optical scanner 10e is an optical, single-pixel, scanning wand that the user waves across the product bar code label. However, any equivalent scanner may be employed with the present invention.

It will be appreciated that the automatic linking device of the present invention is extremely fast because the user does not access the search engine. Moreover, the present invention provides a direct HTML link to the desired web page, thereby obviating the need for sorting through web pages provided by the search engine or surfing the internet.

The present invention is particularly suited for quickly and easily linking the client software to the server software for researching product information without time consuming linking, searching and browsing. By using optical scanner 10e of the present invention, the user can quickly and easily find the internet web page site which includes the desired on-line sales information, on-line product updates or on-line user manuals. For example, the scanned code could be scanned off a computer program box and the product update can be downloadable product update software which is automatically downloaded.

While FIG. 1 illustrates a personal computer, it shall be appreciated that the present invention may be practiced with, for example, main frame computers, local area networks (LAN) or store kiosks.

In a preferred embodiment, the present invention interacts, via a display, with the user. However, the present invention may be transparent to the user which is advantageous when automatically downloading, for example, product updates.

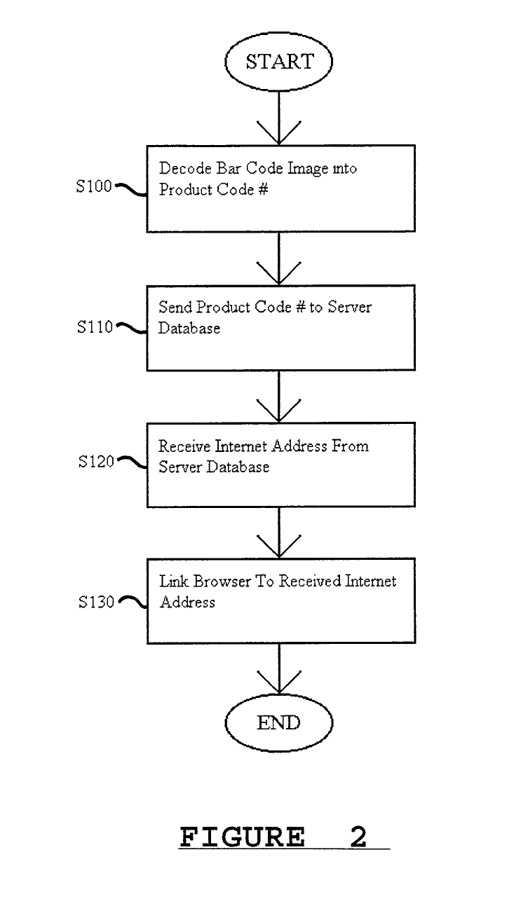

FIG. 2 is a flow diagram of a program, i.e., the client software, for controlling computer 10 to automatically link the client software to the desired web page. It is preferred that the client software is reproduced from the CD drive 10d, but may be downloaded from any equivalent storage medium known in the art.

The client software in Step S100 decodes the bar code image scan into, for example, the product code number corresponding thereto. In Step S110, the client software sends the decoded product code number, via modem 10c and the internet connection, to the server database 30. Upon receipt from the server database of the internet address corresponding to the product code number 40 in Step S120, the client software causes (in Step S130) the local browser to link to the web page indicated by the received internet address. Preferably, the internet address is an internet product page address 50; but the internet address may be any internet address.

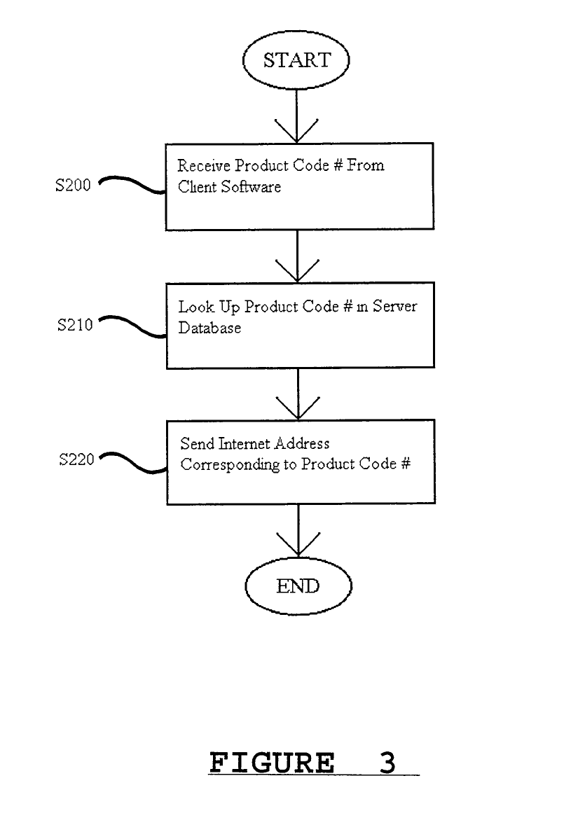

FIG. 3 is a flow diagram of the server software which controls the server database 30. In Step S200, the server database receives the product code number from the client software, via the internet. The server software in Step S210 looks up the product code number in the server database and determines the corresponding internet address. The server software in Step S220 then returns the internet address corresponding to the product code number, via the internet, to the computer 10.

It shall be appreciated that both the client computer and server software may be written in any computer programming language including, but not limited to, C++, assembler or Java™. In particular, Java™ script lends itself to the present invention since this programming language is specifically adapted for internet programming. It shall be appreciated that the computer or server software may be encoded into programmable memory or implemented as an integrated circuit.

The client software is, in another embodiment, incorporated into a web browser. In the alternative, the client software is provided as a plug-in which is imported into the browser software. In more detail, some browsers today provide the user with the capability to add their own software to the browser (the “plug-in”) which allows the user to customize the browser. The present invention may be provided as a plug-in which is imported into the browser which provides such plug-in capability.

In a preferred embodiment, the server software is placed on the internet at a known internet address or on a bulletin board system (BBS). With this arrangement, the server database is updated frequently by, for example, the system manager. Alternatively, the server database may be resident to the computer which provides quick and easy access by the client computer software to the server database.

Preferably, the server software contains a database of bar code numbers and associated manufacturers' internet product page addresses. The client software translates the optically scanned UPC bar code label into a number using image processing techniques. The client software then connects to the server software, sends the product code number thereto and requests internet page information for that product bar code number. The client software, upon receipt of the internet page information, invokes the browser software to link to the internet location indicated by the internet page information received from the server database.

With the present invention, the user quickly and easily links automatically to the desired web page. In particular, when the user desires product information including on-line sales information, on-line product updates and on-line user manuals, the present invention quickly and easily links the user's computer to the appropriate web page.

Although preferred embodiments of the present invention and modifications thereof have been described in detail herein, it is to be understood that this invention is not limited to those precise embodiments and modifications, and that other modifications and variations may be effected by one skilled in the art without departing from the spirit and scope of the invention as defined by the appended claims.

We claim:

1. An automatic internet site link apparatus for linking a computer to an internet page at an internet page address, said apparatus comprising:
means for inputting a code;
means for accessing a server database; and
means for determining from said server database said internet page address corresponding to said code used by said computer to link to said internet page.

2. The automatic internet site link apparatus of claim 1, wherein said means for inputting is an optical scanner.

3. The automatic internet site link apparatus of claim 2, wherein said code is a UPC bar code and said scanner scans said UPC bar code.

4. The automatic internet site link apparatus of claim 1, wherein said server database is at a predetermined remote location from said computer and said means for accessing is a modem for linking said computer to said server database at said predetermined remote location.

5. The automatic internet site link apparatus of claim 4, further comprising means for linking to said internet page at said internet page address corresponding to said code.

6. The automatic internet site link apparatus of claim 5, wherein said internet page address addresses a web page concerning product information; and said means for linking links said computer to said web page at said internet page address.

7. The automatic internet site link apparatus of claim 6, wherein said internet page address addresses said web page concerning product information selected from the group consisting of online sales information, product updates and user manuals; and said means for linking links said computer to said web page at said internet page address.

8. The automatic internet site link apparatus of claim 7, further comprising means for automatically downloading said product information to said computer when said code is inputted.

9. The automatic internet site link apparatus of claim 7, wherein said means for automatically downloading automatically downloads, transparent to a user, said product information to said computer.

10. An automatic internet site link apparatus for linking a computer to an internet page at an internet page address, said apparatus comprising:
an input for inputting a code;
a modem for accessing a server database; and
a processor for determining from said server database said internet page address corresponding to said code used by said computer to link to said internet page.

11. The automatic internet site link apparatus of claim 10, further comprising an optical scanner for scanning said code.

12. The automatic internet site link apparatus of claim 11, wherein said code is a UPC bar code and said scanner scans said UPC bar code.

13. The automatic internet site link apparatus of claim 10, wherein said server database is at a predetermined remote location from said computer and said modem links said computer to said server database at said predetermined remote location.

14. The automatic internet site link apparatus of claim 13, wherein said internet page address addresses a web page concerning product information; and said modem links said computer to said web page at said internet page address.

15. The automatic internet site link apparatus of claim 14, wherein said internet page address addresses said web page concerning product information selected from the group consisting of online sales information, product updates and user manuals; wherein said modem links said computer to said web page at said internet page address.

16. The automatic internet site link apparatus of claim 15, wherein said processor automatically downloads said product information to said computer when said input inputs said code.

17. The automatic internet site link apparatus of claim 15, wherein said processor automatically downloads, transparent to a user, said product information to said computer.

18. An automatic internet site link method for linking a computer to an internet page at an internet page address, said method comprising the steps of:
inputting a code;
accessing a server database; and
determining from said server database said internet page address corresponding to said code used by said computer to link to said internet page.

19. The automatic internet site link method of claim 18, wherein said step of inputting comprises inputting the code using an optical scanner.

20. The automatic internet site link method of claim 19, wherein said code is a UPC bar code, and said step of inputting scans said UPC bar code.

21. The automatic internet site link method of claim 18, wherein said server database is located at a predetermined remote location and wherein said step of accessing links said computer to said server database at said predetermined remote location.

22. The automatic internet site link method of claim 21, further comprising the step of linking to said internet page at said internet page address corresponding to said code.

23. The automatic internet site link method of claim 22, wherein said internet page address addresses a web page concerning product information; and said step of linking links said computer to said web page at said internet page address.

24. The automatic internet site link method of claim 23, wherein said internet page address addresses said web page concerning product information selected from the group consisting of online sales information, product updates and user manuals; and said step of linking links said computer to said web page at said internet page address.

25. The automatic internet site link method of claim 24, further comprising the step of automatically downloading said product information to said computer when said code is input.

26. A method for controlling a computer to automatically link to an internet page located at an internet page address in response to a code input to said computer, comprising the steps of:
accessing a server database;
determining from said server database said internet page address corresponding to said code; and
linking to said internet page located at said internet page address.

27. A method for controlling a computer according to claim 26, wherein said code is scanned into said computer; and said step of determining determines from said server database said internet page address corresponding to said code scanned into said computer.

28. A method for controlling a computer according to claim 26, wherein said step of accessing accesses a server database via a modem connection.

29. The method for controlling a computer according to claim 26, further comprising the step of automatically downloading product information to said computer when said code is input.

30. A method for controlling a server database computer, comprising the steps of:
receiving, via a modem connection, a code input to a remote computer;
determining, from a server database resident to said server database computer, an internet page address corresponding to said code; and
returning said internet page address corresponding to said code.

31. The method for controlling a server database computer according to claim 30, wherein said code is scanned into said remote computer; and said step of determining determines said internet page address corresponding to said code.

32. The method for controlling a server database computer according to claim 30, further comprising the step of automatically uploading product information to said remote computer when said code is received by said server database computer.
